(19) United States
(12) Patent Application Publication
(10) Pub. No.: US 2005/0255253 A1
(43) Pub. Date: Nov. 17, 2005

(54) Apparatus and methods for curing ink on a substrate using an electron beam

(76) Inventors: John M. White, Hayward, CA (US); Fan Cheung Sze, San Jose, CA (US); Quanyuan Shang, Saratoga, CA (US); Shinichi Kurita, San Jose, CA (US); Hongbin Ji, Santa Clara, CA (US); Janusz Jozwiak, San Ramon, CA (US); Inchen Huang, Fremont, CA (US); Emanuel Beer, San Jose, CA (US)

Correspondence Address: DUGAN & DUGAN, PC, 55 SOUTH BROADWAY, TARRYTOWN, NY, 10591, US

(21) Appl. No.: 11/061,121

(22) Filed: Feb. 18, 2005

Related U.S. Application Data
(63) Continuation-in-part of application No. 10/845,629, filed on May 13, 2004.
(60) Provisional application No. 60/625,550, filed on Nov. 4, 2004.

(51) Int. Cl. B05D 1/00; B41J 2/01; C08F 2/46

(52) U.S. Cl. 427/496; 427/8; 347/102

(57) ABSTRACT

In a first aspect, a method of curing ink on a substrate is provided. The method includes the steps of (1) placing a substrate on a support stage of an ink curing chamber; and (2) scanning an electron beam over a surface of the substrate within the ink curing chamber so as to cure ink present on the substrate. Numerous other aspects are provided.

The present application is a continuation-in-part of and claims priority to U.S. patent application Ser. No. 10/845,629, filed May 13, 2004, titled “A METHOD FOR FORMING COLOR FILTERs IN FLAT PANEL DISPLAYS BY INKJETTING” (Attorney Docket No. 9099). The present application also claims priority to U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING” (Attorney Docket No. 9521/L). Each of these applications is hereby incorporated by reference herein in its entirety.

### FIELD OF THE INVENTION

The present invention relates to electronic device manufacturing and, more particularly, to apparatus and methods for curing ink on a substrate using an electron beam.

### BACKGROUND OF THE INVENTION

Each pixel of a flat panel display typically includes sub-pixels filled with red, green or blue ink (although other colors may be used). These sub-pixels may be manufactured using a series of photolithography steps. For example, a photoresist layer may be deposited on a substrate and patterned so as to open all sub-pixel areas in which red ink is to be deposited. Thereafter, red ink may be deposited over the entire substrate, so that the open sub-pixel areas are filled with red ink. The ink may be cured, typically using ultra-violet light, and the photoresist layer may be removed so that only red ink filled sub-pixel areas remain on the substrate. The above process then may be repeated (twice) to complete color filter formation by similarly defining and filing green and blue sub-pixel areas.

While effective, such a process is time consuming and expensive and three separate photolithography steps are required to form the red, green and blue sub-pixels. Likewise, each color generally is deposited in a separate processing chamber, requiring significant fabrication facility resources. Improved methods and apparatuses are necessary to make color filters in production.

### SUMMARY OF THE INVENTION

In a first aspect, the present invention provides a method of curing ink on a substrate that includes the steps of placing a substrate on a support stage of an ink curing chamber; and scanning an electron beam over a surface of the substrate within the ink curing chamber so as to cure ink present on the substrate.

In a second aspect, the present invention provides an apparatus for curing ink. The apparatus includes an electron beam emitter adapted to emit an electron beam, and an electron beam emitter positioning device. The electron beam emitter positioning device is adapted to support the electron beam emitter at a distance above a surface of a substrate containing ink and to move the electron beam emitter so as to scan an electron beam over the surface of the substrate and cure ink present on the substrate. Numerous other aspects are provided.

Each computer program product described herein may be carried by a medium readable by a computer (e.g., a carrier wave signal, a floppy disc, a compact disc, a DVD, a hard drive, a random access memory, etc.).

Other features and aspects of the present invention will become more fully apparent from the following detailed description, the appended claims and the accompanying drawings.

### BRIEF DESCRIPTION OF THE DRAWINGS

FIG. 1 is a functional block diagram of an exemplary ink curing apparatus of the present invention;

FIG. 2 is a perspective view of an exemplary embodiment of an ink curing processing facility of the apparatus of FIG. 1;

FIG. 3 is a top view of the processing facility of FIG. 2;

FIG. 4 is a top view of a processing facility of another exemplary embodiment of the apparatus of the present invention;

FIG. 5 is side view of an exemplary electron beam emitter device which can be used in connection with the apparatus of the present invention;

FIG. 6 is perspective view of the electron beam emitter device of FIG. 5;

FIG. 7 is a flowchart illustrating an exemplary embodiment of the operation of the apparatus and methods of the present invention; and

FIGS. 8A, 8B, and 8C are a flowchart illustrating another exemplary embodiment operation of the apparatus and methods of the present invention.

### DETAILED DESCRIPTION

An alternative approach to forming flat panel displays is to use inkjet printing. During inkjet printing, one or more inkjet print heads (or heads) mounted within a carriage may be moved back and forth across a substrate. As the substrate travels relative to the heads, a control system may activate individual nozzles within the heads to deposit or eject ink (or other fluid) droplets onto predefined wells formed on the substrate. The ink is then cured.

In some instances, the predefined wells formed on the substrate may be damaged if UV curing is employed. Accordingly, it is desirable to develop other curing techniques for flat panel display manufacturing.

The present invention relates to electronic device manufacturing and, more particularly, to apparatus and methods for curing ink on substrates using an electron beam that does not damage predefined wells formed on the substrate. The apparatus and methods of the present invention can be used in curing ink used to form color filters in display objects, display devices, or display panels (hereinafter “display objects”) which are used in manufacturing flat panel displays, such as thin film transistor (TFT) liquid crystal displays (LCD), in a more efficient and cost effective manner.

In one or more embodiments of the invention, an electron beam curing module is provided for curing ink deposited on a substrate. Inks may include, for example, polymers, pigments, dyes, encapsulated pigment, pure pigment plus dye mix, crystal UFH, UFK, and UTT (UV) inks, SOVH and SOVK (solvent) inks, OPK and OPT (oil based) inks, etc. Substrates may be of any size such as, for example, 2,000 cm² to 52,800 cm². The electron beam curing module can include a processing chamber that houses an electron beam emitter. The electron beam emitter is adapted to emit an electron beam that can be scanned and/or moved over a surface of a substrate so as to cure ink previously deposited on the substrate. In one particular embodiment, the electron beam curing module can include an x-ray detector for detecting x-ray leakage from the processing chamber of the electron beam module. Further, the electron beam curing module can include an oxygen detector and/or an ozone detector for detecting undesired levels of these gases within the processing chamber. In response to detection of x-ray leakage from the processing chamber, and/or an undesired level of oxygen and/or ozone within the processing chamber, operation of the electron beam curing module can be halted. A chamber door interlock system or device can also be utilized to ensure that the electron beam curing module is only operated when a door of the processing chamber is properly closed and/or locked.

### System Overview

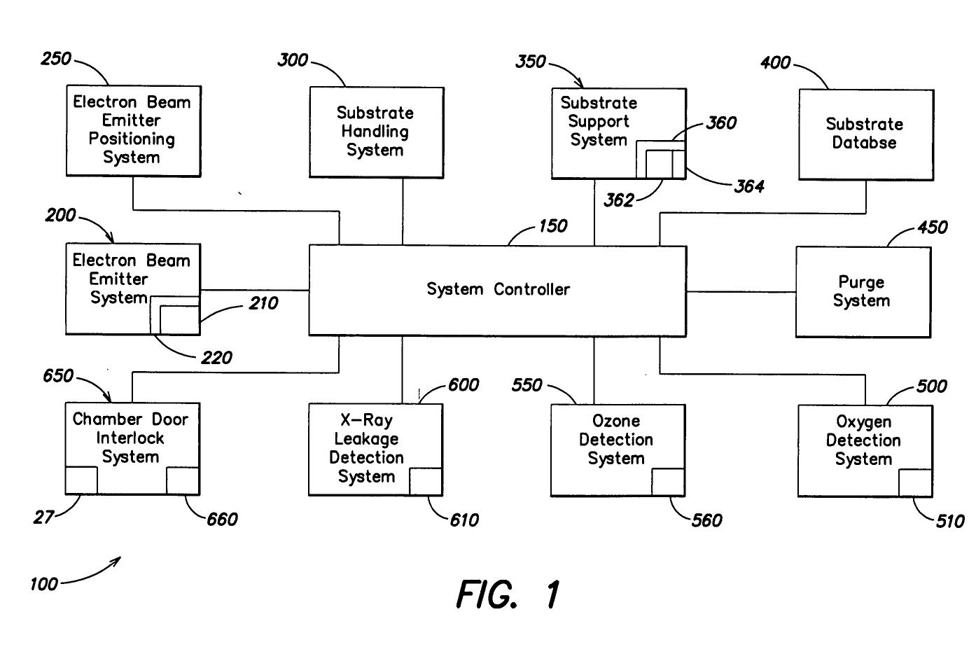

FIG. 1 is a functional block diagram of an exemplary apparatus of the present invention which is designated generally by the reference numeral 100. With reference to FIG. 1, the apparatus 100 includes a system controller 150 coupled to an electron beam emitter system 200 which includes an electron beam emitter device 210 positioned within a processing chamber 220. The electron beam emitter device 210 is adapted to emit an electron beam for curing ink on a substrate positioned with the processing chamber 220. The apparatus 100 also includes an electron beam emitter positioning system 250 coupled to the system controller 150 for moving and/or scanning the electron beam emitter device 210 over a surface of a substrate positioned within the processing chamber 220. A substrate handling system 300 and a substrate support system 350 (having a substrate support stage 360 located within the processing chamber 220) are each coupled to the system controller 150 and may be used for positioning a substrate on the substrate support stage 360 of the processing chamber 220. A substrate database 400 can be employed by the system controller 150 for storing substrate information therein, and a purge system 450 can be provided for purging and/or reducing oxygen and/or ozone levels within the processing chamber 220.

The apparatus 100 can further include one or more of (1) an oxygen detection system 500 having an oxygen sensor or detection device 510; (2) an ozone detection system 550 having an ozone sensor or detection device 560; and/or (3) an x-ray leakage detection system 600 having an x-ray sensor or detection device 610, each coupled to the system controller 150. A chamber door interlock system 650 can also be provided having a door interlock detector 660 for determining whether a door 27 of the processing chamber 220 is properly closed and/or locked (and for providing such information to the system controller 150). Additional details of these and other components of the apparatus 100 are now described.

The system controller 150 can control the operation of the apparatus 100 and one or more of the various electrical and mechanical components and systems of the apparatus 100 which are described herein. In an exemplary embodiment, the system controller 150 can be any suitable computer or computer system, or can include any number of computers or computer systems.

Further, the system controller 150 can be or can include any components or devices which are typically used by, or used in connection with, a computer or computer system. In this regard, the system controller 150 can include a central processing unit(s), a read only memory (ROM) device, a random access memory (RAM) device and/or an input device or user interface device, such as a keyboard and/or a mouse or other pointing device to allow a user to operate or provide control over the apparatus 100. The system controller 150 also can include an output device such as a printer or other device via which data and/or information can be obtained, a display device such as a monitor for displaying information to a user or operator and/or a transmitter and/or a receiver for facilitating communication with other system components and/or in a network environment. The system controller 150 further can include a database for storing any appropriate data and/or information, and/or any other computer components or systems, including any peripheral devices and/or the substrate database 400.

The electron beam emitter system 200 can be, or can include, any suitable electron beam emitter device 210 which can provide an electron beam sufficient for curing ink deposited on any of the herein-described display devices or substrates. In an exemplary embodiment, the electron beam emitter device 210 used in the apparatus 100 can be an Advanced Electron Beams, Inc. 100 Kvolt electron beam source which can provide an electron beam at 100 KVolts having a beam spot of about 10.5″×2″ and a beam uniformity variation of less than ±10%. In some embodiments, other electron beam sources having beam spots of 20 square inches or more may be employed. Beam spots may be formed in any desired shape including rectangular, circular, oval, triangular, etc. Any other suitable electron beam emitter can be used. Any number of electron beam emitter devices 210 can be utilized in the apparatus of the present invention. The system controller 150 can control and/or monitor the operation of the electron beam emitter system 200 and/or any components of the electron beam emitter system 200.

The electron beam emitter positioning system 250, as will be described in more detail herein, can include one or more motors, control device(s) and associated hardware, including mounting hardware, support devices or support arms, etc., for mounting the electron beam emitter device 210 thereon and for moving the electron beam emitter device 210 in an X-axis direction, in a Y-axis direction, and/or in both an X-axis direction and a Y-axis direction, within the ink curing chamber 220 during an operation of the apparatus 100.

The electron beam emitter positioning system 250 can be designed to have any desired stroke capability in both the X-axis direction and the Y-axis direction. In an exemplary embodiment, the electron beam emitter positioning system 250 can have an X-axis direction stroke distance range of motion of greater than 750 mm and a Y-axis direction stroke distance range of motion of greater than 1180 mm.

The electron beam emitter positioning system 250 can also be designed to move the electron beam emitter device 210 with any appropriate speed in the X-axis direction and the Y-axis direction. In an exemplary embodiment, the electron beam emitter positioning system 250 can be designed to provide an X-axis direction speed of greater than 750 mm per 2 seconds and a Y-axis direction speed of greater than 1180 mm per 2 seconds.

The electron beam emitter positioning system 250 can also include any suitable movement detection device (not shown) for detecting and/or monitoring any movement of the electron beam emitter device 210 such as, for example, a linear encoder and/or other equivalent devices. The system controller 150 can control and/or monitor the operation of the electron beam emitter positioning system 250 and/or any components of the electron beam emitter positioning system 250.

The substrate handling system 300 which can be used to physically handle a substrate having one or more display devices prior to, during, and/or subsequent to, any ink curing operation which can be performed by the apparatus 100. The substrate handling system 300 can be, or can include, any equipment, device(s), or system(s), which can be utilized to handle a substrate or substrates once inside the ink curing chamber 220 of the apparatus 100 and during any processing operation(s).

In an exemplary embodiment, the substrate handling system 300 can include any number of substrate lift pins and/or conveyance devices, and/or any associated hardware which can be used to lower a substrate onto a stage, to lift a substrate from a stage, and/or to move a substrate to or from a stage. The substrate handling system 300 can also include a positioning device (not shown) which can be adapted to detect a physical position of a substrate in order to detect and determine a proper positioning or orientation of the substrate prior to and/or during a respective processing operation. The system controller 150 can control and/or monitor the operation of the substrate handling system 300 and/or any components of the substrate handling system 300.

The substrate support system 350 which can support and effectuate a movement of the substrate support stage 360 used for supporting and moving a substrate(s). In an exemplary embodiment, a substrate having one or more display objects (e.g., one or more display panels) can be placed on the stage 360 when being processed in the inking curing chamber 220 of the present invention.

The stage 360 can be of any suitable size to accommodate the substrate or substrates to be processed by the apparatus 100. In an exemplary embodiment, the stage 360 can be capable of holding substrates having dimensions of 750 mm×950 mm and 1100 mm×1300 mm (or any other size).

The substrate support stage 360 can be, for example, a stationary supporting surface for a substrate. In another embodiment, the stage 360 can be an X-Y table which can be adapted to move in the X-direction, in the Y-direction, and/or in both the X-direction and the Y-direction. In one or more embodiments, the stage 360 can also be adapted to rotate (e.g., manually or via a motor or other suitable rotating mechanism) in either or both of a clockwise direction or a counter-clockwise direction, so as to facilitate any orientation or re-orientation of the stage 360 and/or a substrate and the display object(s) located thereon.

The stage 360 can also include a vacuum device 362 or a suction device which can be used for securing a substrate on the top surface of the stage. A vacuum device 362 may include a vacuum pump (not shown), grooves and/or holes in the top surface of the stage 360, piping, etc. to allow vacuum pressure to be applied to the substrate. Other securing devices may be used. Alternatively, a substrate can be held in place on the stage 360 by gravity, with no suction, vacuum, or hardware being utilized to hold the substrate in place. In some embodiments, the stage 360 may include one or more substrate movement detection devices 364 that indicate whether the substrate has shifted out of position on the stage 360. Such substrate movement detection devices 364 may be coupled to the system controller 150 and/or the substrate handling system 300.

The substrate support system 350 can also include one or more motors, control device(s) and associated hardware, including mounting hardware, support devices or support arms, etc., for mounting the stage 360 thereon and for moving the stage 360 in an X-axis direction, in a Y-axis direction, and/or in both an X-axis direction and a Y-axis direction. The substrate support system 350 can also include any suitable movement detection device (not shown) for detecting and/or monitoring any movement of the stage 360. In an exemplary embodiment, the movement detection device can be, or can include, any number of linear encoders or other equivalent devices. The system controller 150 can control and/or monitor the operation of the substrate support system 350 and/or any components of the substrate support system 350.

The substrate database 400 can store data and/or information regarding the type or types of substrate(s), display device(s), etc. which can be processed by the apparatus 100, the type or types of ink or inks which can be utilized in connection with the substrate(s) or display device(s), ink curing rates, power levels, curing times, ink curing scanning patterns, and/or any other information which may be pertinent to and/or relevant to any ink curing process and/or use or operation of the apparatus 100. The system controller 150 can control and/or monitor the substrate database 400.

The purge system 450 can include a gas supply or container and a dispensing device or dispensing devices for dispensing N₂ or another suitable gas (e.g., argon) into the ink curing chamber 220 so as to reduce the level of Oxygen in the same (as oxygen may produce Ozone when struck by an e-beam). The purge system 450 also can include an exhaust and/or vacuum system for removing nitrogen from the chamber 220. In an exemplary embodiment, the ink curing chamber 220 of the apparatus 100 can be purged with N₂ to reduce Oxygen (O₂) and so as to reduce and/or prevent the formation of Ozone (O₃) during an electron beam curing operation. For example, the purge system 450 can operate throughout the ink curing process as described herein. Likewise, the purging rate of the ink curing chamber 220 can be increased to purge any excessive levels of Oxygen (O₂) and/or Ozone (O₃) which may be detected. The purge system 450 can be connected to, controlled by, and/or monitored by, the system controller 150.

The Oxygen (O₂) detection system 500 can include any number of Oxygen (O₂) sensors or detection devices 510 which can sense or detect the presence of Oxygen (O₂) in the ink curing chamber 220. Each Oxygen (O₂) sensor or detection device 510 can be located at any appropriate location inside the ink curing chamber.

Upon detection of Oxygen (O₂), a respective sensor or detection device 510 can generate an appropriate Oxygen (O₂) detection signal and provide the same to the controller 150. The controller 150, upon receiving, detecting, and/or processing the Oxygen (O₂) detection signal, can (1) activate the purge system 450 so as to purge, reduce or eliminate the presence or level of Oxygen (O₂) in the ink curing chamber; (2) prevent the electron beam emitter 210 and/or the apparatus 100 from activating or turning on if an undesired level of Oxygen (O₂) is detected; and/or (3) deactivate or turn off the electron beam emitter 210 and/or the apparatus 100 and/or sound an alarm (not shown) if an undesired level of Oxygen (O₂) is detected during operation of the electron beam emitter 210. In an exemplary embodiment, Oxygen (O₂) of less than about 0.3% may be required to prevent the generation or formation of Ozone (O₃) during an e-beam curing operation.

The Ozone (O₃) detection system 550 can include any number of Ozone (O₃) sensors or detection devices 560 which can sense or detect the presence of Ozone (O₃) in the ink curing chamber 220. Each Ozone (O₃) sensor or detection device 560 can be located at any appropriate location inside the ink curing chamber.

In an exemplary embodiment, the Ozone (O₃) detection system 500 can prevent the electron beam emitter 210 and/or the apparatus 100 from activating or turning on if an undesired level of Ozone (O₃) is detected. In another exemplary embodiment, the Ozone (O₃) detection system 500 can deactivate or turn off the electron beam emitter 210 and/or the apparatus 100 and/or sound an alarm (not shown) if an undesired level of Ozone (O₃) is detected during operation.

For example, upon detection of Ozone (O₃), a respective sensor or detection device 560 can generate an appropriate Ozone (O₃) detection signal and provide the same to the controller 150. The controller 150, upon receiving, detecting, and/or processing the Ozone (O₃) detection signal can (1) activate the purge system 450 so as to purge, reduce or eliminate the presence or level of Ozone (O₃) in the ink curing chamber; (2) prevent activation of the electron beam emitter 210; and/or (3) turn off or deactivate the electron beam emitter 210.

The X-ray leakage detection system 600 can include any number of X-Ray sensors or detection devices 610 located outside or on the exterior of the ink curing chamber 220 and/or in the vicinity of the ink curing chamber 220. An X-Ray sensor or detection device 610 can be located anywhere on the exterior or the ink curing chamber 220 and/or at any location in a room or premises wherein the ink curing chamber 220 is located. Since X-rays can be dangerous to an operator or individuals in close proximity to the ink curing chamber 220, any detected leakage of X-rays may require a shutting down of an operation of the apparatus 100 until the problem resulting in the leakage is repaired or rectified.

In an exemplary embodiment, the X-ray leakage detection system 600 can prevent the electron beam emitter 210 and/or the apparatus 100 from activating or turning on if X-ray leakage about a predetermined level is detected. In another exemplary embodiment, the X-ray leakage detection system 600 can deactivate or turn off the electron beam emitter 210 and/or the apparatus 100 and/or sound an alarm (not shown) if a predetermined level of X-ray leakage is detected during operation.

For example, upon detection of X-ray leakage, a respective X-ray sensor or detection device 610 can generate an appropriate X-ray leakage detection signal and provide the same to the controller 150. The controller 150, upon receiving, detecting, and/or processing the X-ray leakage detection signal can de-activate the electron beam emitter 210 and/or the apparatus 100.

The chamber door interlock system 650 can include the door interlock detector 660 which can detect when the chamber door 27 of the ink curing chamber 220 is not locked, not locked properly, and/or not completely closed. Since X-rays can be generated and emitted from the electron beam emitter 210, it is important that the ink curing chamber door 27 be properly closed and/or locked. The door interlock detector 660 of the chamber door interlock system 650 can detect a door 27 not properly closed and/or in an improperly locked condition, and generate an appropriate “door not closed” or “door not locked” signal and provide the same to the controller 150.

In an exemplary embodiment, the chamber door interlock system 650 can prevent the electron beam emitter 210 and/or the apparatus 100 from activating or turning on if a “door not closed” or “door not locked” condition is detected. In another exemplary embodiment, the chamber door interlock system 650 can deactivate or turn off the electron beam emitter 210 and/or the apparatus 100 and/or sound an alarm (not shown) if a “door not closed” or “door not locked” condition is detected during operation.

For example, the controller 150, upon receiving, detecting, and/or processing the “not closed” or “not locked” signal can de-activate or prevent activation of the electron beam emitter 210 and/or the apparatus 100.

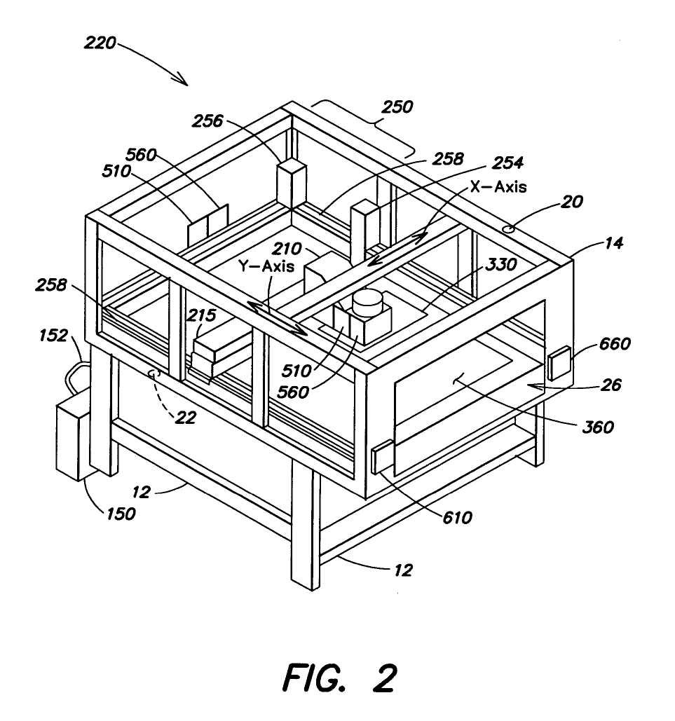

FIG. 2 is a perspective view of an exemplary embodiment of the ink curing processing chamber 220 of the apparatus 100 of FIG. 1. With reference to FIG. 2, the ink curing processing chamber 220 includes a base frame 12 and a housing 14 as shown. In an exemplary embodiment, the housing 14 can be formed of aluminum or any other suitable material and can have a lead plate lining (not separately shown) throughout the same so as to provide sufficient protection from or against radiation leakage, such as, for example, X-ray leakage, from the respective electron beam emitter 210 or other electron beam device which is utilized in the apparatus 100. For example, a lead plate lining having a thickness of 3.2 mm can be used to provide sufficient protection against X-ray leakage. Other lining thicknesses may be used.

With reference once again to FIG. 2, the ink curing processing chamber 220 also includes a purge valve 20 and an exhaust port 22 for supplying purge gas (e.g., nitrogen, air, etc.) to the chamber 220 and/or for exhausting gas from the chamber 220. The ink curing chamber 220 also includes a door opening 26 through which substrates can be transferred into, and/or removed from, the ink curing processing chamber 220. A chamber door 27 (removed for clarity from FIG. 2 but see FIGS. 1 & 3) which is used to close and seal the door opening 26 can, in an exemplary embodiment, be made from Aluminum or any other suitable metal and can be lined with lead so as to provide sufficient protection from or against radiation leakage, such as, for example, X-ray leakage. The chamber door 27 (FIGS. 1 & 3) can be automatically operated and/or manually operated.

Lead shielding or plating may be used in any wall or structure of the ink curing processing chamber 220 in order to protection from the radiation or radiation leakage which typically may be associated with use of electron beam devices such as the electron beam emitter device 210.

With reference once again to FIG. 2, the electron beam emitter device 210 of the electron beam emitter system 200 is also shown. Other components of the electron beam emitter system 200 shown in FIG. 2 include an electron beam device support 215 on which the electron beam curing device 210 can be mounted and moved about inside the ink curing chamber 220. The ink curing chamber 220 also includes the electron beam device positioning system 250 which can control and effectuate movement of the electron beam emitter device 210. Operation of the electron beam device positioning system 250 can be controlled and/or monitored, for example, by the system controller 150 which is also shown in FIG. 2. In FIG. 2, cable 152 is used to connect the system controller 150 to the components of the processing chamber 220. Other communication types/mediums may be used such as wireless communication.

In an exemplary embodiment, the electron beam device positioning system 250 includes an X-axis actuator 254, which is adapted to move the electron beam emitter device 210 in the X-axis direction, and a Y-axis actuator 256 which is adapted to move the electron beam emitter device 210 in the Y-axis direction (e.g., along rails 258). In this regard, the electron beam emitter device 210 can be moveable in both the X-axis direction and in the Y-axis direction and may be scanned over a substrate (not shown) for curing inks deposited thereon.

With reference once again to FIG. 2, the stage 360 which can support a substrate 330 having one or more display devices is also shown. As illustrated, the electron beam emitter device 210 is supported above the stage 360 and substrate 330 and can be moveable relative to and above the stage 360 and substrate 330. In FIG. 2, the substrate 330 is held in place on the top surface of the stage 360 by gravity. In another embodiment, the substrate 330 can be held in place by a vacuum device or a suction device (not shown) or by a clamp or other hardware device (also not shown).

An X-ray sensor 610 is also shown adjacent the door opening 26 in FIG. 2. Any number of X-ray sensors or detection devices 610 can be utilized and can be placed at any location on the exterior structure of the ink curing chamber 220 as well as at any location in the vicinity of the ink curing chamber 220.

With reference once again to FIG. 2, in an exemplary embodiment, an Oxygen (O₂) sensor or detection device 510 and/or an Ozone (O₃) sensor or detection device 560 can be mounted to an inner wall of the housing 14. Alternatively or additionally, an Oxygen (O₂) sensor or detection device 510 and/or an Ozone (O₃) sensor or detection device 560 can be mounted to the moveable electron bean emitter device 210, as shown. Any number of Oxygen (O₂) sensors or detection devices 510 and/or Ozone (O₃) sensors or detection devices 560 can be utilized inside the processing chamber 220 and can be mounted to any stationary and/or moveable components of the processing chamber 220.

A door interlock detector 660 is also shown in FIG. 2 as being mounted adjacent to the opening 26.

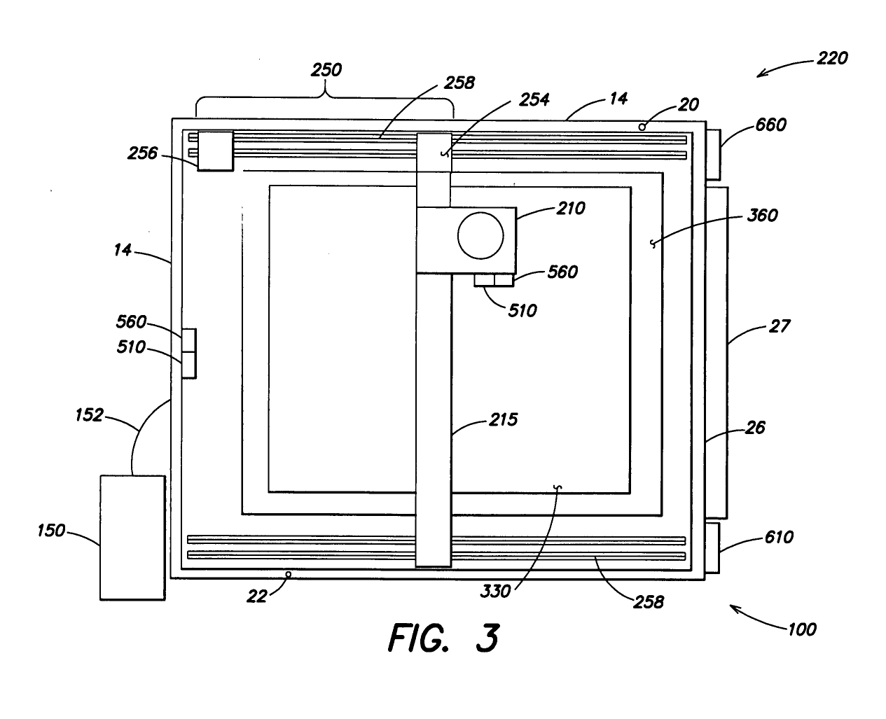

FIG. 3 is a top view of the processing chamber 220 of FIG. 2 shown with the top wall of the housing 14 removed. With reference to FIG. 3, the above-described elements of the processing chamber 220 and/or the apparatus 100 are shown from a top view perspective. In this regard, FIG. 3 shows the purge valve 20, the exhaust port 22, the door opening 26 and the X-ray sensor 610 and the door interlock detector 660 shown mounted adjacent to the door opening 26. A chamber door 27 and the system controller 150 are also shown in FIG. 3.

With reference once again to FIG. 3, shown as being located within the ink curing processing chamber 220 are the stage 360, the substrate 360, the electron beam emitter device 210, and the electron beam device support 215 on which the electron beam curing device 210 can be mounted and moved about inside the ink curing processing chamber 220. In the exemplary embodiment of FIG. 3, an Oxygen (O₂) sensor or detection device 510 and an Ozone (O₃) sensor or detection device 560 can be mounted to an inner wall of the housing 14 and/or on the electron beam emitter device 210 as shown.

With reference once again to FIG. 3, also shown are the electron beam device positioning system 250, the X-axis actuator 254, the Y-axis actuator 256, and the rails 258. FIG. 3 also illustrates an electrical connection 152 between the system controller 150 and each of the purge valve 20, the exhaust port 22, the X-ray sensor 610, the door interlock detector 660, the electron beam emitter device 210, the Oxygen (O₂) sensor or detection device 510, the Ozone (O₃) sensor or detection device 560, and the electron beam device positioning system 250.

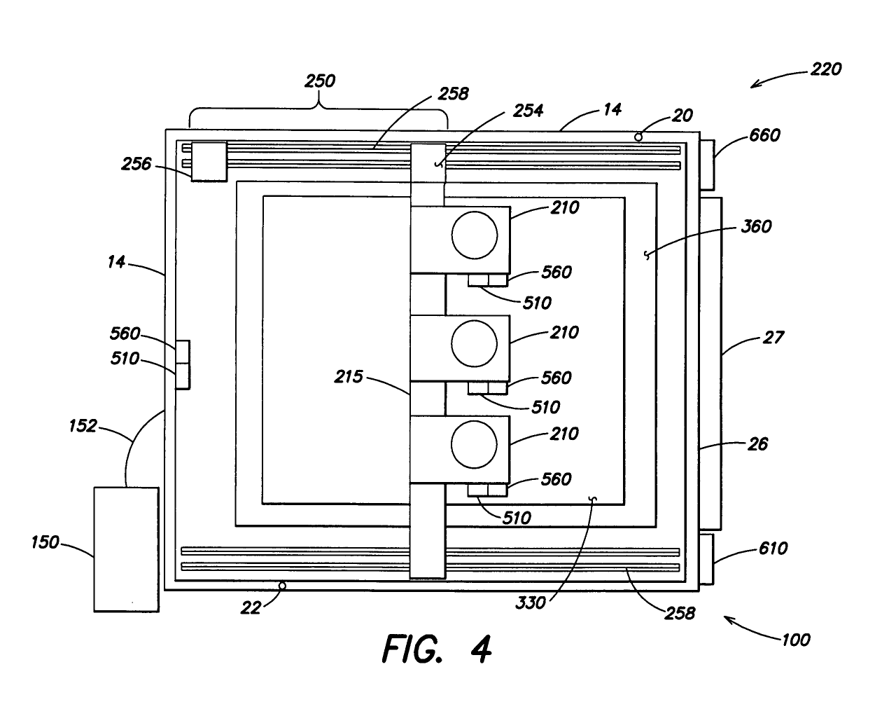

In another exemplary embodiment, the apparatus 100 can be equipped with a plurality of electron beam emitter devices 210 which can be arranged in an array in order to facilitate performing ink curing for a larger area of substrate. FIG. 4 is a top view of a processing chamber of another exemplary embodiment of the apparatus of the present invention wherein the apparatus 100 is provided with a plurality of electron beam emitter devices which are arranged in an array.

In the exemplary embodiment of FIG. 4, three electron beam emitter devices 210 are shown as being mounted on the electron beam device support 215. It is important to note although FIG. 4 shows three electron beam emitter devices 210 being utilized and being arranged in a side-by-side array manner, any number of electron beam emitter devices 210 can be utilized in the apparatus 100 and can be arranged in any suitable manner or fashion.

FIG. 4 further shows the other components of the apparatus 100 and/or the processing chamber 220 described above in connection with the exemplary embodiments of FIG. 2 and FIG. 3.

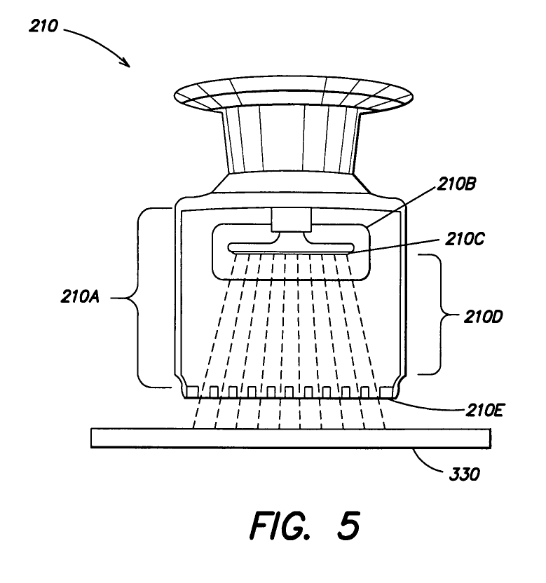

FIG. 5 is side view of an exemplary electron beam emitter device 210 which can be used in connection with the apparatus of the present invention. As noted above, in an exemplary embodiment, the electron beam emitter device 210 can be an Advanced Electron Beams, Inc. 100 Kvolt electron beam source which can provide an electron beam at 100 KVolts and having a beam spot of about 10.5″×2″. The beam spot is a measure of the aperture through which the electron beam is emitted. Other electron beam emitters may be used.

A large beam spot allows for a more efficient ink curing process and may dispense with a need to operate the electron beam emitter 210 with precise alignment. In this regard, pre-alignments, rotations, etc., of the substrate 330 relative to the electron beam emitter 210 can be dispensed with.

With reference once again to FIG. 5, the electron beam emitter device 210 includes a vacuum chamber 210A, a high voltage plate (HVP) element 210B, a filament 210C, an acceleration zone 210D and a foil 210E which, in an exemplary embodiment, can be a titanium foil or a silicon foil. For example, the foil 210E can be a Titanium foil having a thickness of about 6 microns or a Silicon foil having a thickness of about 2-3 microns. Other foil types and/or sizes may be used. In an exemplary embodiment, the foil 210E has a number of slots, slits, holes, and/or apertures formed therein.

In one particular embodiment, the electron beam emitter device 210 is held above the substrate 330 so that the foil 210E is situated at a distance of approximately 2 to 3 millimeters from the substrate 330. Other distances may be used. A small gap between the foil 210E and the substrate 330 is preferred during curing so as to reduce the incidence of collisions between electrons emitted from the electron beam emitter device 210 and air molecules and so as to maximize the amount of electron beams which strike the ink on the display object(s) of the substrate 330. In such embodiments, the stage 360 may be operable to move down during load and unload operations to provide sufficient clearance between the stage 360 and foil 210E for loading and unloading. This allows the emitter device 210 to remain stationary. More specifically, in some embodiments, the stage 360 may be operable to move downward a certain amount away from the foil 210E to provide clearance above the substrate 330. The stage 360 then may continue to move downward to allow stationary lift pins (not shown) to protrude through openings in the stage 360 and to contact and support the substrate 330 as the stage 360 continues to lower to provide sufficient clearance below the substrate 330, e.g., for an atmospheric robot to remove the substrate 330 from the lift pins and to then insert a new substrate 330 on the lift pins. The stage 360 may then be raised to contact the new substrate and position the substrate below the emitter device 210.

In operation, a high voltage of, for example, about 80-100 kVolts is applied to the HVP element 210B and current of, for example, about 10-20 mAmps is passed through the filament 210C. The high voltage applied to the HVP element 210B strips electrons from the filament 210C. The electrons accelerate toward the foil 210E and pass through the slots, slits, holes, and/or apertures formed therein. The electrons pass toward and through the foil 210E and hit or strike ink on the display object(s) of the substrate 330 and thereby cure the ink.

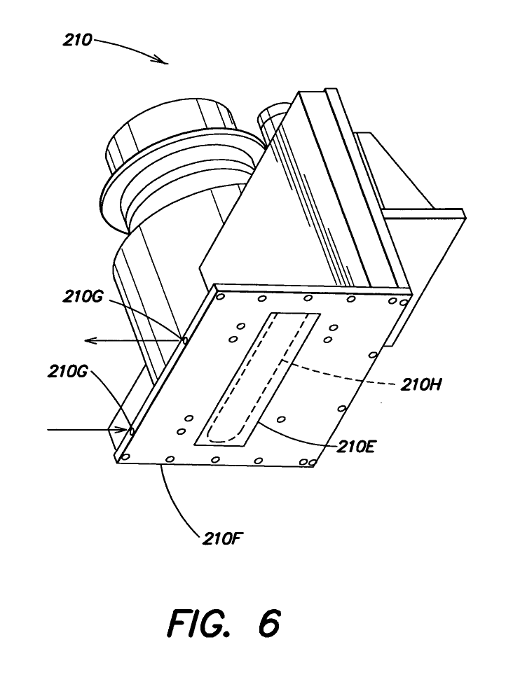

FIG. 6 is perspective view of the electron beam emitter device of FIG. 5. With reference to FIG. 6, the electron beam emitter device 210 also includes a face plate 210F. The faceplate 210F has a series of channels 210G therein and therethrough for providing cooling water through the face plate 210F. The cooling water is provided from a reservoir (not shown) and supply system (not shown). The cooling water serves to cool the face plate 210F during operation of the electron beam emitter device 210.

FIG. 6 also illustrates the foil 210E and an electron beam window 210H. An electron beam is directed through the electron beam window 210H and toward the substrate 330.

The apparatus and methods of the present invention allow ink on a substrate or on substrates to be cured by using an electron beam. In an exemplary embodiment, the electron beam is provided by the electron beam emitter device 210 which is supported a distance above the substrate and is moveable relative to the substrate. The electron beam emitter device 210 can be moved across the substrate such as by being scanned across the substrate while the electron beam is emitted therefrom. The electron beam emitter device 210 can moved across the substrate in a continuous scanning motion, or by being moved or scanned across the substrate in a step-wise manner, such as by being moved in discrete steps. The electron beam can be emitted during the entire scanning process.

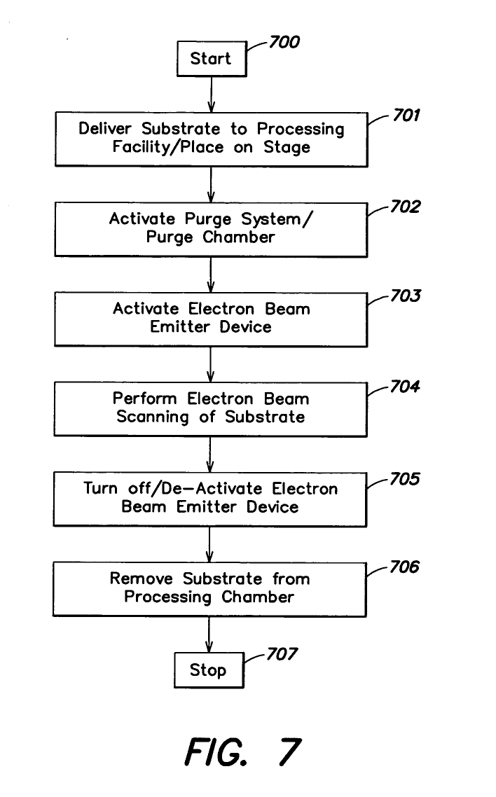

FIG. 7 is a flowchart illustrating an exemplary embodiment of the operation of the apparatus and methods of the present invention.

With reference to FIG. 7, the operation of the apparatus 100 commences at step 700. At step 701, the substrate 330 having ink previously deposited thereon is delivered to the processing chamber 220 and placed on the stage 360. At step 702, the purge system 450 is activated and the processing chamber is purged of undesirable gases such as Oxygen. In some embodiments, the purge system 450 may continue to purge undesirable gases during the entire ink curing process described herein. In alternative and/or additional embodiments, the purge system 450 may purge gases in response to the electron beam emitter device 210 being active.

At step 703, the electron beam emitter device 210 is activated. Once activated, the electron beam emitter device 210 emits an electron beam which is used to cure the ink previously deposited on the substrate 330.

At step 704, the substrate 330 is scanned with the electron beam emitter device 210 and the ink previously deposited on the substrate 330 is cured. Once the scanning process is completed at step 704, the electron beam emitter device 210 is turned off at step 705.

At step 706, the substrate 330 can be removed from the processing chamber 220. The operation of the apparatus 100 will thereafter cease at step 707.

In another exemplary embodiment, the electron beam scanning operation illustrated in FIG. 7 can be performed with a plurality of electron beam emitter devices 210.

In yet another exemplary embodiment, the apparatus and methods of the present invention can be utilized in connection with one or more of the Oxygen (O₂) detection system 500, the Ozone (O₃) detection system 550, the X-ray leakage detection system 600, and/or the chamber door interlock system 650 as described below.

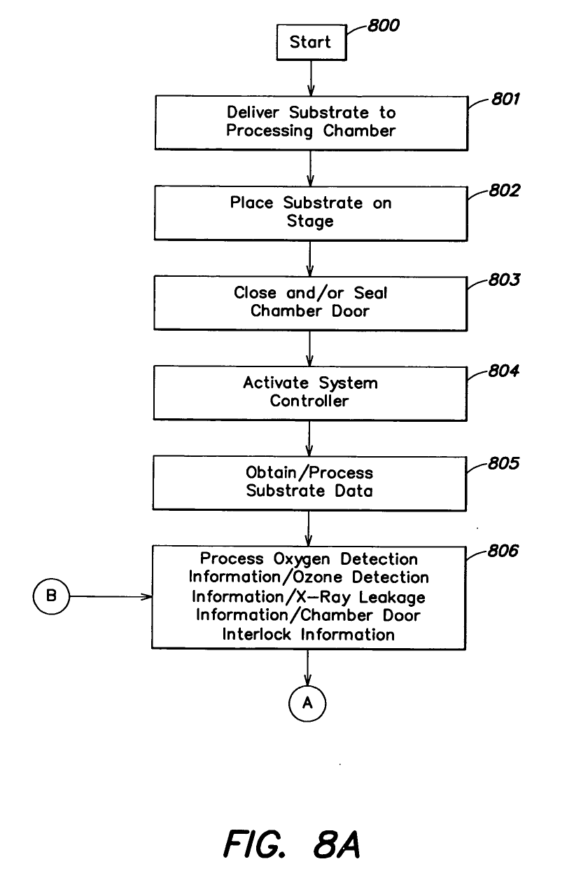

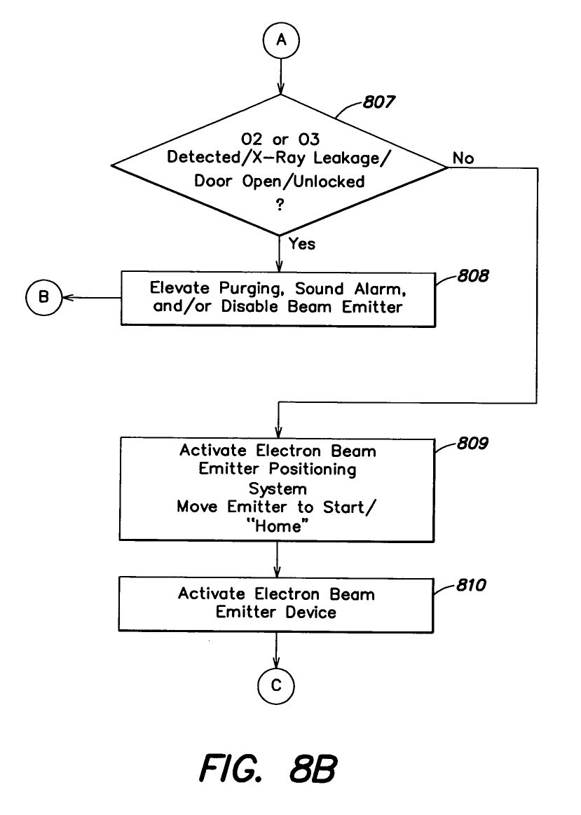

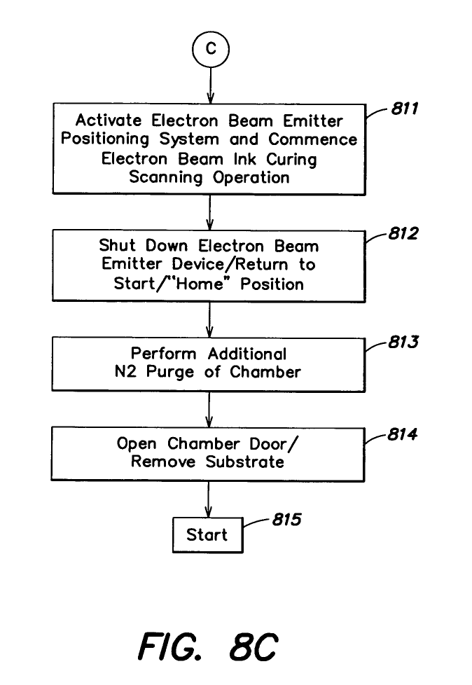

FIGS. 8A, 8B, and 8C illustrate a flowchart of another exemplary ink curing operation of the apparatus 100 of the present invention. With reference to FIGS. 8A, 8B, and 8C, the operation of the apparatus commences at step 800. At step 801, the substrate 330 is delivered to the processing chamber 220 and at step 802 the substrate is placed on the stage 360.

At step 803, the chamber door 27 is closed and/or sealed so as to prevent the leakage of gases and X-rays from the processing chamber 220.

At step 804, the system controller 150 can be activated. At step 805, the system controller 150 can obtain and process data regarding the substrate to be processed. For example, the system controller 150 can obtain substrate data from the substrate database 400. As described above the substrate data can include data and/or information regarding one or more of the type of substrate, a display device on the substrate, the type of ink to be cured, the ink curing rate, power level, curing time, ink curing scanning pattern, and/or any other data and/or information which may be pertinent to the operation of the apparatus 100.

At step 805, the system controller can also activate the purge system 450 and purge the ink curing chamber 220 of gases such as Oxygen (O₂). In an exemplary embodiment, Nitrogen gas (N₂) can be used to purge the ink curing chamber 220. The purge system 450 may continue to operate during the operation of the apparatus 100 if desired. In at least one embodiment, as described herein, the purge system 450 can be controlled to provide purging at an enhanced purging level or rate if Oxygen (O₂) or Ozone (O₃) is detected during the ink curing process.

At step 806, the system controller 150 can process information regarding one or more of the Oxygen (O₂) detection system 500, the Ozone (O₃) detection system 550, the X-ray leakage detection system 600, and/or the chamber door interlock system 650, in order to respectively ensure that no unsafe levels of Oxygen (O₂) or Ozone (O₃) are present in the chamber 220, that no X-ray leakage is detected, and/or that the chamber door 27 is properly closed and/or sealed.

At step 807, the system controller 150 can perform a test on one or more of the Oxygen (O₂) detection system 500, the Ozone (O₃) detection system 550, the X-ray leakage detection system 600, and/or the chamber door interlock system 650, in order to respectively ensure that no unsafe levels of Oxygen (O₂) or Ozone (O₃) are present in the chamber 220, that no X-ray leakage is detected, and/or that the that the chamber door 27 is properly closed and/or sealed. If, at step 807, it is determined that one or more unsafe levels of Oxygen (O₂) or Ozone (O₃) are present in the processing chamber, that X-ray leakage is detected, and/or that the chamber door 27 is not properly sealed or locked, the processing of the system controller 150 may proceed to step 808, and the system controller 150 can (1) elevate the purging level of the purge system 450 to reduce the level of Oxygen (O₂) or Ozone (O₃); (2) sound an alarm to provide an alert; and/or (3) disable activation of the electron beam emitter device 210.

Upon completion of step 808, the system controller 150 may proceed to step 806 and repeat the above processing and testing until it is determined that the ink curing process can safely proceed.

If, at step 807, it is determined that the Oxygen (O₂) or Ozone (O₃) levels are within safe limits, that no X-ray leakage is present, and that the chamber door 27 is properly closed and locked, then operation will proceed to step 809.

At step 809, the system controller 150 activates the electron beam emitter positioning system 250 and moves the electron beam emitter device 210 to the start or “home” position relative to the substrate. The start or “home” position can be determined from data and/or information obtained from the substrate database 400. At step 810, the system controller 150 activates the electron beam emitter device 210. For example, the power level at which the electron beam emitter device 210 is operated can also be controlled by the system controller 150 and can be determined based upon data and/or information obtained for the particular substrate from the substrate database 400.

At step 811, the system controller 150 activates the electron beam emitter positioning system 250 and commence scanning the electron beam emitter device 210 and, hence, the electron beam emitted therefrom, over and across the substrate surface. The electron beam cures the ink on the substrate as it is scanned over the ink.

In an exemplary embodiment, the scanning pattern used to move the electron beam emitter 210 can be obtained from the substrate database 400 and the system controller 150 can control the electron beam emitter positioning system 250 so that the electron beam emitter device 210 is scanned over the substrate so as to effectuate a complete ink curing operation. The system controller 150 can also control the scanning speed of the electron beam emitter device 210.

During step 811, the system controller 150 can automatically effectuate the scanning of the electron beam emitter device 210 over the substrate until the scanning pattern and for example, all requisite X-axis direction and/or Y-axis direction movements of the electron beam emitter device 210 are performed for the substrate. Any suitable scanning patterns can be employed. For example, any suitable longitudinal, raster, and/or any other scanning convention can be utilized until the scanning operation is completed.

In an exemplary embodiment, the scanning operation performed during step 811 can be accomplished by performing a continuous scanning motion, with the ink being cured as the electron beam from the electron beam emitter device 210 is passed over the substrate. Alternatively, the scanning operation performed during step 811 can be accomplished by performing a discrete step scanning motion, whereby the electron beam emitter device 210 is moved in discrete steps through the scanning pattern.

In an exemplary embodiment wherein an array of electron beam emitter devices 210 is utilized, such as described in connection with FIG. 4, the scanning pattern can be adjusted to account for the additional electron beam emitter devices 210 which are utilized.

During the electron beam scanning and ink curing operation which takes place during step 811, the system controller 150 can simultaneously monitor, receive data and/or information from, and/or process data and/or information from or regarding, one or more of the Oxygen (O₂) detection system 500, the Ozone (O₃) detection system 550, the X-ray leakage detection system 600, and/or the chamber door interlock system 650. If, at any time, any undesired condition arises, the system controller 150 can control a suitable response.

For example, if Oxygen (O₂) or Ozone (O₃) is detected in the processing chamber 220, the system controller 150 can employ, during step 811, the purge system 450 to reduce the level of Oxygen (O₂) or Ozone (O₃). If X-ray leakage is detected, the system controller 150 can shut down the electron beam emitter device 210 and sound an appropriate safety alarm. If the chamber door 27 is determined to have become unlocked or opened, the system controller 150 can shut down the electron beam emitter device 210 and sound an appropriate safety alarm. Other responses may be performed or initiated.

Once the scanning and ink curing operation is completed at step 811, the system controller 150 can, at step 812, shut down the electron beam emitter device 210, and/or return the electron beam emitter device 210 to the start or “home” position. At step 813, the system controller 150 can employ the purge system 450 to reduce any level(s) of Oxygen (O₂) and/or Ozone (O₃). At step 814, the chamber door 27 can be opened and the substrate 330 can be removed from the processing chamber 220. Thereafter, the operation of the apparatus 100 will cease at step 815.

The foregoing description discloses only exemplary embodiments of the invention. Modifications of the above disclosed apparatus and methods which fall within the scope of the invention will be readily apparent to those of ordinary skill in the art. For instance, another suitable electron beam source may include, but is not limited to, an electron gun as disclosed in commonly assigned U.S. patent application Ser. No. 10/055,869, which was filed on Jan. 22, 2002 under the title “Electron Beam Lithography System Having Improved Electron Gun,” which is incorporated by reference herein in its entirety. Examples of chemical substituents which may serve as effective electron beam crosslinking substituents suitable for inclusion in the monomers and/or oligomers contained in the color ink may include, but are not limited to, (a) carbon-carbon double bonds (for example, an alkene functionality built into or attached onto a pendent group, such as an adamantyl cage) or attached either to the pendant group or a polymer; (b) “strained” ring systems such as, for example, and without limitation, three (3) or four (4) member cycloalkanes prone to ring opening and cross-linking upon exposure to electron beam irradiation; (c) halogenated compounds such as for example, a halomethyl substituent prone to cross-linking under electron beam irradiation through processes correlated with the extrusion of a hydrogen halide (such as, for example, HCl); and/or (d) one or more organo-silicon moieties, which are more particularly described in commonly assigned U.S. patent application Ser. No. 10/447,729, which was filed on May 28, 2003 under the title “E-Beam Curable Resist And Process For E-Beam Curing The Resist,” which is incorporated by reference herein in its entirety.

As used herein, the term electron beam, or e-beam, treatment refers to exposure of a film to a beam of electrons, for example, and without limitation, a relatively uniform beam of electrons. As used herein, the term electron beam source, or electron beam emitter, or e-beam emitter refers to a device capable of producing an electron beam. It is preferred that the e-beam treatment step be conducted using a wide, large beam of electron radiation from a uniform, large-area electron beam source. In one embodiment, such an electron beam source may simultaneously cover an entire substrate area or display object. In a production environment where the substrate size is larger than the broad e-beam source, the color filters may be scanned by the electron beam emitter in a manner to achieve a uniform exposure by the electron beam. The e-beam treatment may be conducted, for example, at atmospheric pressure. Another suitable electron beam chamber includes the ElectronCure™ chamber that is available from Applied Materials, Inc. of Santa Clara, Calif. The principles of operation and performance characteristics of such an apparatus are described in commonly assigned U.S. Pat. No. 5,003,178, which is incorporated by reference herein in its entirety. The electron beam energy may be in a range from about 1 to about 200 KeV, depending on processing pressure and conditions, although other energy ranges may be employed. The total dose of electrons for the polymerization of the color filters may be adjusted according to the type and thickness of color filters, chamber or enclosure conditions, speed of substrate movement, and/or e-beam energy.

The gas ambient in the electron beam chamber can include, but is not limited to, nitrogen, oxygen, hydrogen, argon, xenon, helium, carbon dioxide, or any combination of two or more of these gases. The e-beam treatment is preferably conducted at atmospheric pressure. In one embodiment, when a vacuum chamber is employed, the vacuum conditions may be maintained at a pressure range from just below atmospheric pressure to about 10⁻⁷ Torr. Other pressures may be employed. In at least one embodiment, the temperature of the substrate may vary in a range from about 20° C. to about 200° C. In a particular embodiment, the temperature may be controlled in the range from 20° C. to 80° C. Other temperature ranges may be used (e.g., room temperature). In addition, for thick films, the electron beam dose may be divided into steps of decreasing voltage which provides a uniform dose process in which the material is cured from the bottom up. Thus, the depth of electron beam penetration may be varied during the treatment process. As those of ordinary skill in the art can readily appreciate, the length of e-beam treatment may depend on one or more of the above-identified parameters.

Accordingly, while the present invention has been disclosed in connection with exemplary embodiments thereof, it should be understood that other embodiments may fall within the spirit and scope of the invention, as defined by the following claims.

1. A method of curing ink on a substrate comprising:
placing a substrate on a support stage of an ink curing chamber; and
scanning an electron beam over a surface of the substrate within the ink curing chamber so as to cure ink present on the substrate.

2. The method of claim 1 wherein scanning the electron beam over the surface of the substrate comprises moving an electron beam emitter over the surface of the substrate.

3. The method of claim 1 wherein scanning the electron beam over the surface of the substrate comprises moving a plurality of electron beam emitters over the surface of the substrate.

4. The method of claim 2 wherein moving the electron beam emitter comprises moving the electron beam emitter in at least one of an x-axis direction and a y-axis direction.

5. The method of claim 1 further comprising detecting a level of oxygen in the ink curing chamber.

6. The method of claim 5 further comprising determining if the level of oxygen is above a predetermined level, and if so at least one of purging the ink curing chamber and disabling the electron beam.

7. The method of claim 6 wherein disabling the electron beam comprises turning off the electron beam.

8. The method of claim 6 wherein disabling the electron beam comprises preventing an activation of the electron beam.

9. The method of claim 1 further comprising detecting a level of ozone in the ink curing chamber.

10. The method of claim 9 further comprising determining if the level of ozone is above a predetermined level, and if so at least one of purging the ink curing chamber and turning off the electron beam.

11. The method of claim 1 further comprising detecting a level of x-ray leakage from the ink curing chamber.

12. The method of claim 11 further comprising determining if the level of x-ray leakage is above a predetermined level, and if so turning off the electron beam.

13. The method of claim 1 further comprising detecting an open or unlocked condition of a door of the ink curing chamber.

14. The method of claim 13 further comprising determining if the door of the ink curing chamber is open or unlocked and, if so, disabling the electron beam.

15. The method of claim 1 further comprising purging the ink curing chamber with an inert gas during scanning of the substrate.

16. The method of claim 15 wherein purging the ink curing chamber with an inert gas during scanning of the substrate comprises purging the ink curing chamber with nitrogen.

17. An apparatus for curing ink, comprising:
a chamber having:
an electron beam emitter adapted to emit an electron beam; and
an electron beam emitter positioning device, wherein the electron beam emitter positioning device is adapted to support the electron beam emitter at a distance above a surface of a substrate containing ink and move the electron beam emitter so as to scan an electron beam over the surface of the substrate and cure ink present on the substrate.

18. The apparatus of claim 17, further comprising a controller adapted to control operation of the apparatus.

19. The apparatus of claim 18, wherein the controller is adapted to control the electron beam emitter positioning device.

20. The apparatus of claim 17 further comprising a plurality of electron beam emitters each adapted to scan an electron beam over the surface of the substrate.

21. The apparatus of claim 17 wherein the electron beam emitter positioning device is adapted to move the electron beam emitter in at least one of an x-axis direction and a y-axis direction.

22. The apparatus of claim 17 further comprising an oxygen detector adapted to detect a level of oxygen in the ink curing chamber.

23. The apparatus of claim 22 further comprising a controller coupled to the oxygen detector and adapted to determine if the level of oxygen is above a predetermined level, and if so initiate at least one of purging the ink curing chamber and disabling the electron beam.

24. The apparatus of claim 17 further comprising an ozone detector adapted to detect a level of ozone in the ink curing chamber.

25. An apparatus for curing ink, comprising:
a chamber having:
an electron beam emitter adapted to emit an electron beam;
an electron beam emitter positioning device, wherein the electron beam emitter positioning device is adapted to support the electron beam emitter at a distance above a surface of a substrate containing ink and move the electron beam emitter so as to scan an electron beam over the surface of the substrate and cure ink present on the substrate.
an ozone detector adapted to detect a level of ozone in the ink curing chamber;
a controller coupled to the ozone detector and adapted to receive a signal from the ozone detector, determine if the level of ozone is above a predetermined level, and if so activate at least one of purging the ink curing chamber and turning off the electron beam;
an x-ray detector coupled to the controller and adapted to detect a level of x-ray leakage from the ink curing chamber, wherein the controller is adapted to receive a signal from the x-ray detector, determine if the level of x-ray leakage is above a predetermined level, and if so initiate turning off the electron beam;
an interlock system coupled to the controller and adapted to detect an open or unlocked condition of a door of the ink curing chamber, wherein the controller is adapted to receive a signal indicating whether the door of the ink curing chamber is open or unlocked and, if so, initiate turning off the electron beam; and
a purging system coupled to the controller and adapted to purge the ink curing chamber with an inert gas in response to an activation signal from the controller,
wherein the electron beam emitter positioning device is adapted to remain at a constant z-axis position during substrate load/unload operations,
wherein the apparatus further includes a stage adapted to support the substrate, and
wherein the stage is adapted to be lowered so as to allow stationary lift pins to protrude through the stage, support the substrate, and provide clearance above and below the substrate when the stage is lowered.
